(19) United States
(12) Patent Application Publication
(10) Pub. No.: US 2011/0093611 A1
(43) Pub. Date: Apr. 21, 2011

(54) NETWORK UNIT, A CENTRAL DISTRIBUTION CONTROL UNIT AND A COMPUTER PROGRAM PRODUCT

(76) Inventors: Mikael Lind, Sollentuna (SE); Robert Skog, Hasselby (SE); Andreas Ljunggren, Vallingby (SE)

(21) Appl. No.: 12/666,929

(22) PCT Filed: Jun. 29, 2007
(86) PCT No.: PCT/SE07/50475

§ 371 Date: Jan. 4, 2011

(51) Int. Cl. G06F 15/16

(52) U.S. Cl. 709/236

(57) ABSTRACT

A network unit for use in a real-time communications network in which streams of data frames are transmitted to a plurality of receivers, said network unit being arranged to receive at least a first part of at least a first stream of data frames transmitted from at least a first content source is described, said unit being characterized in that it comprises At least one buffer arranged to store each data frame of a stream of data frames; A transmitting unit arranged to communicate with at least one other network unit to transmit at least one data frame to another network unit; A receiving unit arranged to receive from said other network unit at least one data frame belonging to the stream of data and store said data frame in the at least one buffer.

### TECHNICAL FIELD

The present invention relates to a communications network in which streamed data is sent to a number of receivers, such as an Internet Protocol Television (IPTV).

### BACKGROUND AND RELATED ART

At present, in Internet Protocol Television (IPTV) one or more video streams are transmitted to receivers from a fixed set of content transmitters. The transmission may be unicast (one-to-one), for example as video on demand, or a multicast or broadcast solution (one-to-many). A receiver in such a network receives content from one such transmitter, with hard real-time requirements. Hence, the core networks must be modified to suit the transmission technologies used.

Such a receiver is commonly called a set-top box. The term set-top box (STB) describes a device that receives a signal from an external source, and forwards it to, for example, a television set, turning the signal into content then displayed on the screen. The signal source might be, for example, an Ethernet cable, a telephone line (including DSL connections), Broadband over Power Line, or even an ordinary Very High Frequency (VHF) or Ultra High Frequency (UHF) antenna. Content, in this context, could mean any or all of, audio, Internet webpages, interactive games, or other types of content.

Multicast is another communication method in which one source sends the same information to a number of receivers. The article “http://www.icir.org/floyd/srm-paper.html”, IEEE/ACM Transactions on Networking, December 1997, Volume 5, Number 6, pp. 784-803 discloses a so called reliable multicast distribution in which a node can ask neighbours for packets which it has not received. Multicast differs from IPTV in that in a multicast system the source always knows to which receivers the information is sent.

In the future, other types of applications having some degree of real-time requirements are foreseeable, for example, user-defined TV content, interactive TV, and interactive or cooperative games. Soft real-time requirements imply that a media stream should be delivered to the recipient at a continuous rate to avoid interruptions in, for example, a streamed sound and/or image output. The actual timing of the overall stream is not critical. The requirement is that the peer clients and servers together are able to deliver a sufficient bandwidth that the client can reassemble the content in a steady manner to the video-decoder. The invention introduces a certain amount of latency. A couple of seconds' latency should be acceptable to subscribers for regular content, since they already accept a certain latency for video transmitted via satellites.

In this document, when reference is made to a transmitter, or a receiver, respectively, it should be noted that these terms may also cover transceivers, that is, according to Wikipedia, nodes in which the same circuitry is used for receiver and transmitter functions. In other words, the terms transmitter and receiver cover all types of nodes that have transmitting functions, or receiving functions, respectively.

### SUMMARY OF THE INVENTION

It is an object of the invention to improve the efficiency in a transmission network in which one unit transmits streamed information to a number of receiving units. This object is achieved according to the present invention by a network unit for use in a communications network in which streams of data frames are transmitted to a plurality of receivers, said network unit being arranged to receive at least a first part of at least a first stream of data frames transmitted from at least a first content source, characterized in that it comprises
At least one buffer arranged to store each data frame of a stream of data frames temporarily;
A transmitting unit arranged to communicate with at least one other network unit to transmit at least one data frame stored in said buffer to the at least one other network unit; and
A receiving unit arranged to receive from said at least one other network unit at least one data frame belonging to the stream of data and store said data frame in the at least one buffer.

In one aspect the invention also relates to a central distribution control unit for use in a communications network in which streams of data frames are transmitted to a plurality of receivers, said central distribution control unit comprising means for receiving from at least one receiver in the network information about which frames of a stream of data frames the at least one receiver has received and means for transmitting to the at least one receiver an order to forward at least one of the received frames to another receiver in the network.

The invention will improve the network capacity for media streams having soft real-time requirements, that is, for media streams that should be transmitted and displayed to the user at a continuous rate. By using a sliding window buffer it is possible to enable the perception of a live stream being gathered from multiple transmitters in a distributed peer-to-peer network, in a way that fulfils soft real-time requirements.

Using the buffers and the communication between them according to the invention each client does not have to receive all content from one content ingestion point, since it can request the content from peer clients. Indeed, it is advantageous to receive as much of the content as possible from peer nodes, as this will reduce the strain on the content transmitter. If multiple television sets in one household, or connected to the same local network, are watching the same channel only one copy needs to be transmitted over the connection to the house without any requirements on the internal structure within the household, apart from a sufficient bandwidth between the television sets.

The receiving unit may also be arranged to receive from said at least one other network unit a request for at least one data frame and the transmitting unit is arranged to transmit the at least one data frame if it is found in the at least one buffer.

If a central distribution control unit is present in the network, the receiving unit may also be arranged to receive from a central distribution control unit in the network an order to transmit at least one data frame to the at least one other network unit and the transmitting unit may be arranged to transmit the at least one data frame if it is found in the at least one buffer. In this case, the transmitting unit may also be arranged to transmit to the central distribution control unit in the network information about the data frames it has received from the content source and from other network units.

The network unit according to the invention may be a router in the network arranged to forward the at least one data stream to at least one receiver in the network

The network unit preferably further comprises a reassembling unit for reassembling the data stream and means for forwarding the reassembled data stream to a display unit for presentation to a user. In this way the network unit does not have be comprise a display unit but can be used together with any type of device comprising a display, such as an ordinary television set. The network unit may also itself comprise display means for presenting the reassembled data stream to a user.

The buffer may be, for example, a sliding window ring buffer, and is preferably associated with a second buffer for storing the addresses to any key frames that are stored in the buffer. In this way, when another network unit requests frames from the stream contained in the buffer, the first available key frame can be found and transmitted to the other network unit quickly. The key frames are frames at which the display of a stream can start. One type of key frame is an I-frame, which is discussed as an example only, in this document.

The network unit may also comprise means for monitoring the sharing of information between the network units. In this way a distributed monitoring function can be implemented to ensure that all network units actually share the information they have received.

One aspect of the invention relates to a communications system comprising at least a first content source arranged to transmit at least a first stream of data frames to a plurality of receivers, characterized in that the receivers are receivers as defined above. The communication system may further comprise a central distribution control unit as defined above, for communicating with the receivers, and/or at least one distribution logic unit arranged to monitor the sharing of information between the network units.

The invention enables a single sender to send to a large volume of suscribers with a minimum of upstream bandwidth, thus allowing subscribers to receive content independently of operator domains, internet domains or country regions, assuming that the subscriber has sufficient privileges to unlock any Digital Rights Management (DRM) encryption used if the stream is encrypted.

The content injector can be a public television channel or a private driven channel such as a live-video-blog. The more subscribers a specific channel has, the more intra-domain bandwidth can be saved according to the invention.

Multicast assumes that all content is introduced in a fairly limited set of ingestion points, and has high demands on the actual infrastructure. In comparison, peer-to-peer networks, as used in the present invention, can traverse Network Address Translation (NAT) firewalls, country borders and operators without any major obstacles.

The latency introduced in the stream will differ slightly between different clients, so that, in the case of a video stream, the different users will not view exactly the same image at the same time. The nature of peer-to-peer balancing, however, ensures that the latency is similar in adjacent nodes, which are probably geographically close to each other. In this way the risk of, for example, hearing the neighbours cheering for a football goal prior to seeing the actual goal, is limited.

The fragmentation is not necessarily based on (Moving Pictures Experts Group) MPEG frames. It would probably be more effective to fragment in Maximum Transmission Unit (MTU) based sizes, such as approximately 1500 bytes on Ethernet. The reassembled stream can be MPEG or any other suitable media stream.

### BRIEF DESCRIPTION OF THE DRAWINGS

The invention will be described in more detail in the following, by way of example and with reference to the appended drawings in which:

FIG. 1 illustrates schematically a simple IPTV network.

FIGS. 2 and 3 illustrate the exchange of frames according to the invention.

FIG. 4 illustrates a buffer used in each receiver according to the invention.

FIG. 5 illustrates a network according to an embodiment of the invention in which a central distribution control unit is used to monitor the traffic in the network.

FIG. 6 illustrates a set-top box, or receiver, modified according to the invention.

FIG. 7 illustrates a buffer for one selected channel in a set-top box.

FIG. 8 is an example of a snapshot of the buffer memory inside a STB at a given point in time.

### DETAILED DESCRIPTION OF EMBODIMENTS

FIG. 1 illustrates a simple IPTV network according to the invention. As is common in such networks, a media server 1 is arranged to transmit streamed data through a network comprising a first 3 and a second router 4. The first router 3 supplies streamed data from the media server 1 to the second 4 and third 5 router. The second router supplies data to a first receiver 7, commonly referred to as a set-top box. The third router 5 supplies streamed data to a second 8 and a third 9 receiver of essentially the same type. A fourth set-top box 10 is connected to one or more of the other set-top boxes 7, 8, 9 but not to the media server 1 or routers 3, 5.

As an example, a first sequence of frames comprising, for example, images belonging to a first video stream can be transmitted to the first receiver 7 and a second sequence of images belonging to a second video stream can be transmitted to the second 8 and/or the third receiver 9. It should be noted that this is only intended as an example. A real network will have more media servers, more routers, and each router will serve a greater number of receivers with the same or different streams.

According to the invention, each receiver, or set-top box, 7, 8, 9, 10 is arranged to communicate with one or more of the other receivers. In this way, according to the invention each receiver can, and should, request frames that it has not received from other receivers and send frames that it has received, to other receivers. In the example network shown in FIG. 1, all receivers 7, 8, 9, 10 can send data to each other, represented by bidirectional arrows between all receivers. In the simplest case this applies to receivers receiving the same data stream, in this case, the second and third receivers 8, 9. In this case, in particular, frames received by the second receiver 8 can be transmitted from the second receiver 8 to the third receiver 9 and vice versa. In this way, the media server only has to transmit some of the frames to the second receiver 8 and the remaining frames to the third receiver 9. The fourth receiver 10 can only receive frames from other receivers 7, 8, 9. For sorting the frames into the buffer in the correct position any suitable solution known in the art may be used. For example a pointer list, or pre-allocated slots may be used. Preferably, each receiver 7, 8, 9, 10 is arranged to store received frames even after they have been displayed and only discard them when the memory space is needed for new frames. This is because different receivers may receive the same data stream with a certain delay relative to each other, so that another receiver may wish to receive frames that have already been displayed on the first receiver.

According to the invention, the media server 1 comprises, or is connected to a distribution logic unit 11. FIG. 1 shows the distribution logic unit 11 as included in the media server 1. The distribution logic keeps track of what is sent and to which receiver, and also monitors that all receivers actively share content that they have received, when requested.

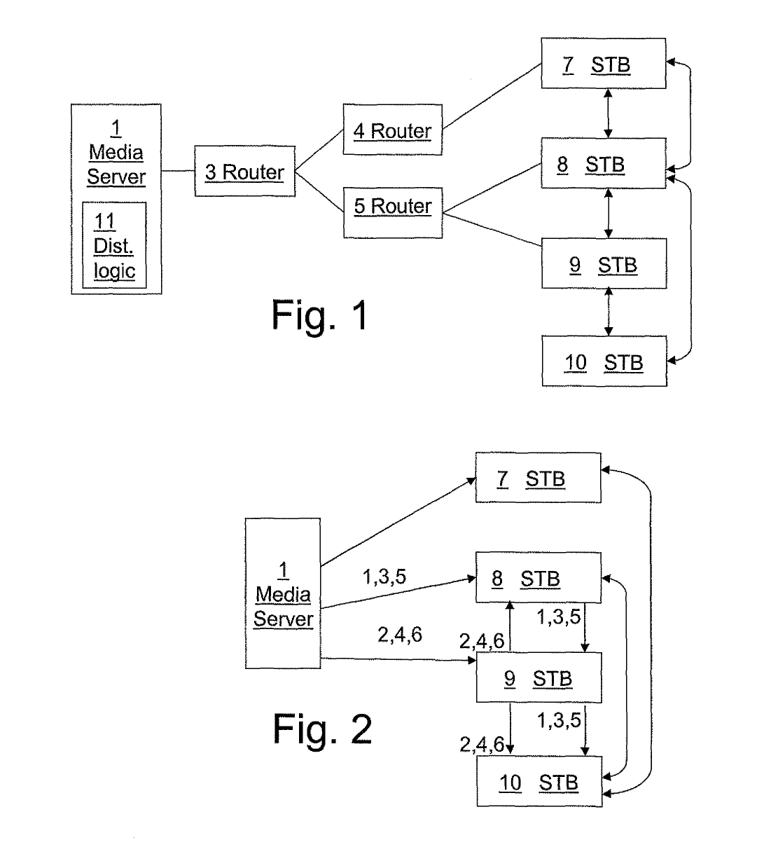

Such a situation is depicted in FIG. 2, in which, for simplicity, the routers are not shown. In reality, there will be other network units connected between the media server 1 and the receivers 7, 8, 9. The second 8 and third 9 receivers receive the same stream. Merely as an example, it is assumed that the second receiver 8 only receives odd-numbered images, that is, image number 1, 3, 5 etc. The third receiver 9 receives the even-numbered images, that is, image number 2, 4, 6 etc. The second 8 and third receiver 9 can then request from each other the frames they have received, so that both receivers get a complete set of images. In this case, the second receiver 8 will transmit the odd-numbered images to the third receiver 9 and will receive the even-numbered images from the third receiver 9. In this way, the network can be used more efficiently, in that, on average over a period of time, only half the traffic has to be transmitted to each of the users 5 and 9, respectively. If more users are receiving the same stream, the fraction of the traffic distributed to each user can be reduced further.

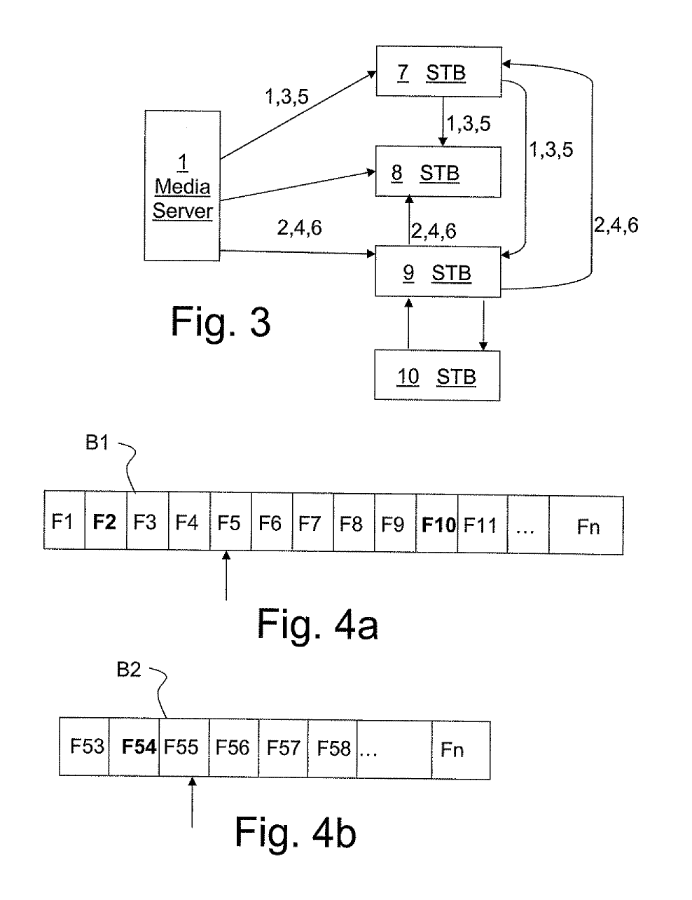

Consider, with reference to FIG. 3, a situation where the first 7, second 8 and third 9 receiver are all receiving the same stream, and some of the images (in this example, the odd-numbered ones) are transmitted to the first receiver 7 and the remaining images of the stream are transmitted to the third receiver 9. In this case, the media server does not have to distribute any images at all to the second receiver 8, since this receiver 8 can receive all images from the first and third receivers, respectively.

In practice, however, it may be advantageous in every embodiment of the invention to send at least some of the images to more than one receiver. In particular, in IPTV, certain frames are defined as possible starting points for viewing, so called key frames, one example of which is I-frames. This may be, for example, the first frame in each scene. If such a frame is lost, all frames between this frame and the next I-frame cannot be viewed, which may mean that a whole scene is lost. Therefore, it is advantageous to transmit these I-frames to more than one of the receivers, possibly to all receivers, to increase the chance that they are received correctly.

This sharing of information between receivers is particularly advantageous if the receivers are connected to the same local network having large capacity and/or low transmission cost. For example, if the receivers are connected to the same Local Area Network (LAN) in principle unlimited amounts of data can be exchanged at no cost.

According to the invention, each receiver 7, 8, 9 comprises a buffer for storing images, to ensure a smooth reassembly of the stream. The buffer could be a ring buffer, or a sliding window buffer or another suitable type of buffer.

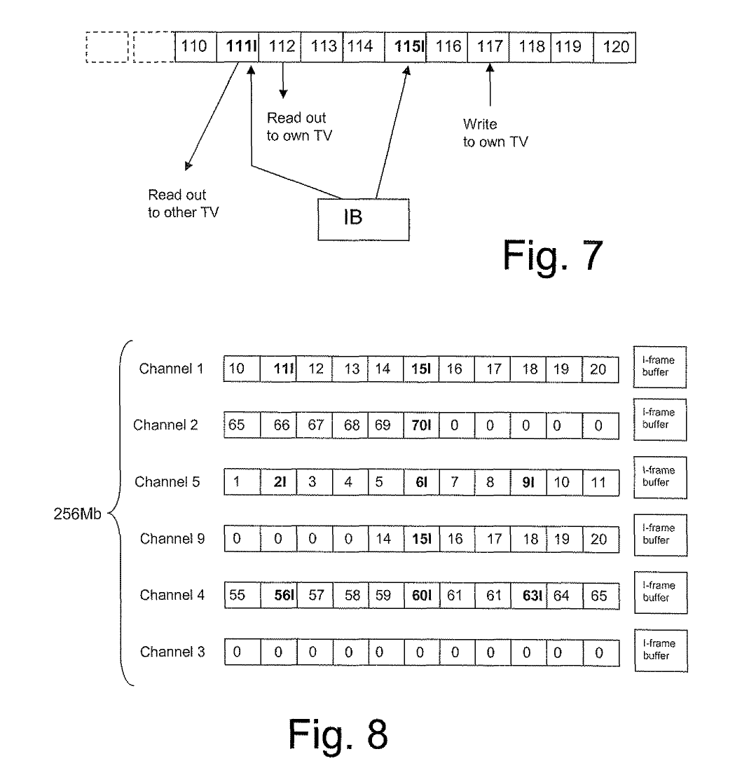

Typically, a set-top box can have a number of channels. FIG. 7 illustrates a buffer for one selected channel. For one channel the STB can hold a number of frames, numbered 110-120 in this Figure. In the example shown in FIG. 7, frames 111I and 115I, indicated in bold, are I-frames. Frame number 112 is currently being sent to the TV decoder, as indicated by an arrow. The frames numbered 118-120 do not contain any information yet. The SIB is currently inserting frame number 117, which has been collected from another STB (or source). When this STB writes a frame into the buffer and finds that it is an I-frame, then the address to this frame is stored in an I-frame buffer IB.

When a “blank” (the other STB has changed channel) “read out” request comes from another STB the “read out” function looks in the “I-frame buffer” to find the first available I-frame. In the example shown in FIG. 7, this is frame “111I”. The read out to another TV therefore starts with frame 111 and continues with 112 etc. as long as the other STB asks for more frames. This “I-frame buffer” makes the channel switch faster.

Assuming that the first buffer 131 of FIG. 4a belongs to the first receiver 7, which is watching the first stream and that the second buffer B2 of FIG. 4b belongs to the second receiver 8, which is watching the second stream. If the second receiver 8 wishes to change channels and start watching the first stream, the second buffer B2 should start storing frames belonging to the first stream. The frames of the second stream already stored in the second buffer may be discarded, but are preferably kept so that the second buffer B2 can transmit them to other receivers that are, or want to start, watching the second stream.

The frames of the first stream may be received by the second buffer B2 from the first buffer B1 belonging to the first user. As mentioned above, it is only possible to start watching the first stream at certain frames, in this example the I-frames F2 or F10, which are indicated in bold characters. Therefore the first buffer B1 should transmit the frames of the first stream to the second buffer B2 starting with either frame F2 or frame F10. In the former case the second receiver 8 will watch the images of the first stream a little delayed compared to the first receiver 7. In the latter case, the second receiver 8 will watch the images of the first stream a little bit ahead of the first receiver 7. If no I-frame is currently stored in the first buffer B1, the second receiver will have to wait before it can start receiving frames belonging to the first stream in such a way that they can be displayed. Hence, the longer the buffer, compared to the interval between the I-frames, the faster the channel can be changed. Therefore, it is feasible for each buffer to contain at least one I-frame at any given time.

A requirement is that the second buffer B2 is able to receive each image before the image is to be shown. It may therefore be advantageous to start with an image that is not near the end of the first buffer B1, in this case F2.

Changing channels will be particularly easy if the new channel is already being received by another receiver in the same LAN or other local network.

Today's video encoding already allows for a buffer that should be sufficiently large for the present invention. For example, a 256 Mb buffer would probably allow for storing more than 30 minutes of TV quality video. This could then be used as multiple small buffers, for example 5 minutes on each of 6 channels. The bandwidth consumption is roughly 8 Mbyte/minute or 1.1 Mbit/s, which should enable the reception of multiple channels on a regular consumer connection at any single time to allow quick channel switching and possible time-shifting.

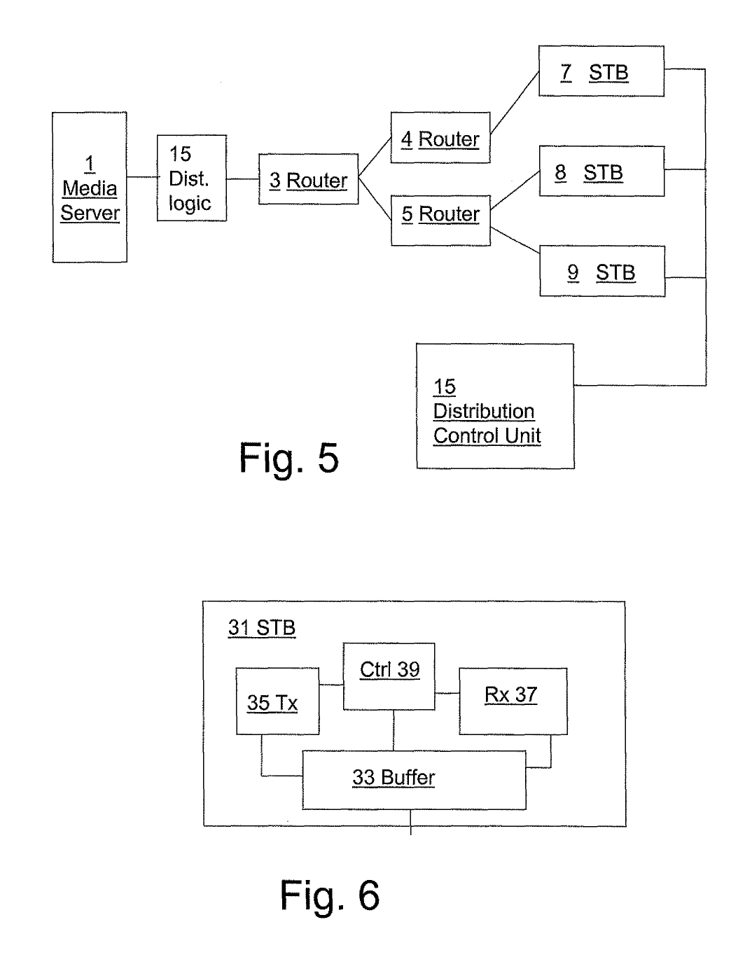

FIG. 5 illustrates a network essentially similar to the one shown in FIG. 1. As in FIGS. 1, 2 and 3, the receivers 7, 8, 9 receive streams from the media server 1 through the network and share frames with each other as needed. There may also be receivers, like the receiver 10 in FIG. 1, that are not connected to the media server 1; however, this is not illustrated in FIG. 5. A distribution unit 11 is found in or in connection to the media server. In FIG. 5 the distribution unit is connected between the media server 1 and the network. In addition to the units shown in FIG. 1, the network of FIG. 5 also comprises a central distribution control unit 15 arranged to perform flow control. The central distribution control unit 15 is a central or distributed function to which all receivers are connected, and which is arranged to control the communication in the network, in particular who is allowed to communicate with whom and at what speed. The connection between the receivers 7, 8, 9 and the central distribution control unit 15 is preferably implemented through the network, although FIG. 5 shows direct connections. In the case of distributed tracking responsibility for different parts of a network can be assigned to different nodes, often referred to as super-nodes. These super-nodes can be any type of node, and enable world-wide distributed networks in which each geographic region is managed by one local node which is responsible for the sharing of information in this particular region. This will avoid the problem of excess overload on a central node.

The central distribution control unit 15 is arranged to receive information from each of the receivers 7, 8, 9 regarding which frames the receiver has received and from whom. The central distribution control unit is responsible for monitoring which receivers are willing to share information with other receivers, so that all receivers actively share the content they have received. The central distribution control unit 15 may also be arranged to handle payments for content, although this is outside the scope of this invention. A user who does not want to participate in actively sharing content can be required to pay an extra fee instead.

If a central distribution control unit 15 is present in the network, the receivers do not have to request missing frames themselves. Instead, other receivers may be ordered by the central distribution control unit 15 to provide the missing frames. Alternatively, the central distribution control unit can inform each receiver about the other receivers receiving the same stream, so that each receiver can request missing frames directly from other receivers. If no central distribution control unit is used, as shown in FIG. 1, the receivers only communicate with each other, and receive data from the media server 1, as shown in FIGS. 1, 2 and 3.

FIG. 6 illustrates a set-top box 31 according to the invention, which may be any of the receivers 7, 8, 9, 10 of FIG. 1. In addition to the functions normally found in a set-top box known in the art, the set-top box 31 according to the invention comprises a buffer 33 for storing frames received from the media server 1 and/or other set-top boxes, as discussed above. The buffer is as discussed in connection with FIGS. 4a and 4b. The set-top box 31 also comprises a transmitter unit 35 and a receiver unit 37, connected to the buffer 33, for communicating with the other set-top boxes in the network. The set-top box 31 also comprises a control unit for controlling the functions of the transmitter unit 35, the receiver unit 37 and the buffer 33. This control unit comprises one or more computer programs for controlling the inventive functions of the set-top box.

The receiver, commonly referred to as a set-top box (STB) in the field of IPTV, may be implemented as a software module in a television set, which will then be able to receive IPTV from the network and display it to the user. Alternatively, the set-top box is implemented as a software module, for example in a personal computer or other terminal having data processing capabilities. The stream can then be forwarded from the set-top box to any display unit, including a television set, or the computer's own display for display to the user.

The functions performed by the receivers according to the invention may instead be performed by units in the network, such as the routers 3, 4, 5, In this case, the receivers 7, 8, 9, 10 do not need to comprise any special functions at all apart from what is found in prior art set-top boxes. Instead, the routers 3, 5 comprises one or more buffers as shown in FIGS. 4a and 4b, and a transmitter and a receiver for communicating directly with the other routers in the network. Preferably each router has one buffer for each channel that the receivers are able to receive, or at least a sufficient number of routers to cater for all the receivers served by it. It will be sufficient that the routers to which receivers are directly connected comprise the buffers, transmitter and receiver.

The networks used for communication between the media server and the receivers, and between receivers, may be any network known in the art providing a sufficient bandwidth, including wire-based or wireless networks, or a combination of both.

While the frames must be displayed to the viewers at a constant rate, the buffer allows for the transmission rate of frames to vary, to the extent where the frames are transmitted in bursts which are handled by the buffer.

At one moment of time, a snapshot of the buffer memory inside a STB can look as shown in FIG. 8. In this case the STB has six channel buffers, each including, or associated with, an I-frame buffer as discussed in connection with FIG. 7. The buffers are receiving, in order from the top down: channel 1, channel 2, channel 5, channel 9, channel 4 and channel 3. The SIB is sending information from one of the six channel buffers towards the TV (and TV-decoder) and at the same time information (i.e. video frames) about previously viewed channels are kept in memory. Due to restriction in buffer size (for example 256 Mb), not all available channels can be stored. If the end-user is only watching one or maybe two channels for a certain period of time the rest of the channel buffers will be empty.

1. A network unit for use in a communications network in which streams of data frames are transmitted to a plurality of receivers, said network unit being arranged to receive at least a first part of a first stream of data frames transmitted from a first content source through the communications network, the network unit comprising:
at least one buffer arranged to store data frames of a stream of data frames temporarily while previously received data frames of the stream are being displayed;
a transmitting unit arranged to communicate with at least one other network unit to transmit at least one data frame stored in said buffer to the at least one other network unit; and
a receiving unit arranged to receive from said at least one other network unit at least one data frame belonging to the stream of data and store said at least one data frame in the at least one buffer.

2. The network unit according to claim 1, wherein the receiving unit is also arranged to receive from said at least one other network unit a request for at least one data frame and the transmitting unit is arranged to transmit the at least one data frame if it is found in the at least one buffer.

3. The network unit according to claim 1, wherein the receiving unit is also arranged to receive from a central distribution control unit in the network an order to transmit the at least one data frame to the at least one other network unit and the transmitting unit is arranged to transmit the at least one data frame upon receiving the order from the central distribution control unit, if it is found in the at least one buffer.

4. The network unit according to claim 1, wherein the transmitting unit is also arranged to transmit to a central distribution control unit in the network information about the data frames it has received from the content source and from other network units.

5. The network unit according to claim 1, said network unit being a router in the network arranged to forward the at least one data stream to at least one receiver in the network

6. The network unit according to claim 1, further comprising a reassembling unit for reassembling the data stream.

7. The network unit according to claim 6, further comprising means for forwarding the reassembled data stream to a display unit for presentation to a user.

8. The network unit according to claim 6, further comprising means for presenting the reassembled data stream to a user.

9. The network unit according to claim 1, wherein the at least one buffer is associated with a second buffer for storing the addresses to any I-frames that are stored in the buffer.

10. The network unit according to claim 1, further comprising means for monitoring the sharing of information between the network units.

11. A central distribution control unit for use in a communications network in which streams of data frames are transmitted to a plurality of network units, said central distribution control unit comprising means for receiving from at least one network unit in the network information about which frames of a stream of data frames the at least one network unit has received through the communications network and means for transmitting to the at least one network unit an order to forward at least one of the received data frames to another network unit in the network.

12. The communications system comprising at least a first content source arranged to transmit at least a first stream of data frames to a plurality of receivers.

13. The communications system according to claim 12, for communicating with the receivers.

14. The communications system according to claim 12, further comprising at least one distribution logic unit arranged to monitor the sharing of information between the network units.

15. A computer program product in a network unit operable on a processor, the computer program product comprising code means which configures the processor to perform one or more functions, comprising:
storing each data frame of a stream of data frames received through the network temporarily while previously received data frames of the stream are being displayed, in a buffer of the network unit;
storing at least one data frame received from said at least one other network unit and belonging to the stream of data, in the at least one buffer; and
transmitting the at least one data frame stored in said buffer to said at least one other network unit upon request.

16. The computer program product according to claim 15, further arranged, when the receiving unit receives from said at least one other network unit a request for at least one data frame, causing the transmitting unit to transmit the at least one data frame if it is found in the at least one buffer.

17. The computer program product according to claim 15, further arranged, when the receiving unit receives from a central distribution control unit in the network an order to transmit at least one data frame to the at least one other network unit, causing the transmitting unit to transmit the at least one data frame upon receiving the order from the central distribution control unit, if it is found in the at least one buffer.

18. The computer program product according to claim 15, further arranged to cause the transmitting unit to transmit to a central distribution control unit in the network information about the data frames it has received from the content source and from other network units.

19. The computer program product according to claim 15, further comprising code means for causing the network unit to reassemble the data stream.

20. The computer program product according to claim 19, further comprising code means for causing the network unit to forward the reassembled data stream to a display unit for presentation to a user.

21. The computer program product according to claim 19, further comprising code means for causing the network unit to present the reassembled data stream to a user.

22. The computer program product according to claim 15, further comprising code means for looking up in a second buffer the addresses to any I-frames that are stored in the buffer, when at least one frame from the stream stored in the buffer is requested from said at least one other network unit.

23. The computer program product according to claim 15, further comprising code means for monitoring the sharing of information between the network units.
